(19) United States
(12) Patent Application Publication
(10) Pub. No.: US 2013/0198102 A1
(43) Pub. Date: Aug. 1, 2013

(54) METHOD AND APPARATUS FOR APPROVING A TRANSACTION

(71) Applicants: Milton Santiago, JR., Chicago, IL (US); Christopher Hope, Toonbridge Kent (GB); John E. Scully, Chicago, IL (US); Darin G. Mallory, Plainfield, IL (US)

(72) Inventors: Milton Santiago, JR., Chicago, IL (US); Christopher Hope, Toonbridge Kent (GB); John E. Scully, Chicago, IL (US); Darin G. Mallory, Plainfield, IL (US)

(73) Assignee: Bank of America, Charlotte, NC (US)

(21) Appl. No.: 13/361,024

(22) Filed: Jan. 30, 2012

(51) Int. Cl. G06Q 10/00

(52) U.S. Cl. 705/342

(57) ABSTRACT

A method and apparatus that improves treasury management functionality for a cash positioning and reporting system is provided. Several portions of the payment process may be improved. The approval process may be streamlined by providing supplemental contact information at each stage of the approval process. Confirmation of payments made via a wire transfer may be sent to a payee. A reference number from the wire transfer may be included in the confirmation. The reference number may permit tracking of the payment by the payee. Likewise, supplemental wire transfer information may be provided to the general ledger system to improve reconciliation of payments and invoices.

### FIELD OF TECHNOLOGY

Aspects of the disclosure relate to a cash positioning and reporting system. Cash positioning typically refers to tracking daily cash positions for an entity and/or management of treasury functions.

### BACKGROUND

For the purpose of this application, treasury functions may include receiving payments, facilitating payments, stopping checks, etc. Facilitation of payments may include facilitating wire transfers or providing access to lines of credit. It should be noted that payments may be in different currencies and may require currency conversion.

Wire transfer or credit transfer is a method of electronic funds transfer from one person or institution (entity) to another. A wire transfer can be made from one bank account to another bank account or through a transfer of cash at a cash office.

Central bank wire transfer systems, such as the Federal Reserve's FedWire system in the United States typically operate as Real time gross settlement (“RTGS”) systems. RIGS systems provide the quickest availability of funds because they provide immediate “real-time” and final “irrevocable” settlement by posting the gross (complete) entry against electronic accounts of a wire transfer system coordinator.

A bank wire transfer may be effected as follows: The entity wishing to do a transfer approaches a bank and gives the bank the order to transfer a certain amount of money. An international bank account number (“IBAN”) and/or other codes are given as well so the bank knows where the money needs to be sent. The sending bank transmits a message, via a secure system (such as SWIFT or Fedwire), to the receiving bank. The message provides payment instructions. The message also includes settlement instructions. The actual transfer may not be instantaneous: funds may take several hours or even days to move from the sender's account to the receiver's account. Either of the banks involved typically holds a reciprocal account with each other, or the payment must be sent to a bank with such an account, a correspondent bank, for further benefit to the ultimate recipient.

The payment process may involve multiple levels of approval. Approval may be a manual or a partially manual process. Confirmation of payment may require multiple phone calls or emails. Tracking of wire transfer payments in a general ledger system may be difficult. Therefore, a system that facilitates one or more of these steps would be desirable.

### SUMMARY

An enhanced treasury management functionality for a cash positioning and reporting system is provided. Several stages of the payment process may be improved. The approval process may be streamlined by providing supplemental contact and reference information at each stage of the approval process. When payments are made via a wire transfer, a reference number may be provided to the payee so that payment can be confirmed and tracked. Likewise, supplemental wire transfer information may be provided to a general ledger system to improve reconciliation of payments and invoices.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows a schematic diagram of an exemplary payment system according to the invention;

FIG. 3 shows a flow diagram for an exemplary payment system according to the invention;

FIG. 4 shows a schematic diagram of an exemplary approval process;

FIG. 5 shows a schematic diagram of an exemplary payment system with confirmation according to the invention; and

FIG. 6 shows a schematic diagram of an exemplary payment system with reconciliation enhancements according to the invention.

### DETAILED DESCRIPTION OF THE DISCLOSURE

An enhanced treasury management functionality for a cash positioning and reporting system is provided. Aspects of the approval process may be streamlined by providing supplemental information at each stage of the approval process. Such information may include contact information. The approval process may be the approval of an invoice. At each stage of the approval process a list of previous approvers may be provided, showing a “chain of approver-ship”. Typically, the last approvers are more senior. The senior approver may wish to change some portion of the invoice or confirm details with a particular junior approver. The chain of approver-ship facilitates changes and confirmations.

When payments are made via a wire transfer, a reference number may be provided to the payee so that payment can be confirmed and tracked. The reference number may be accompanied by additional information to facilitate tracking of the payment by the payee. Typically, a wire transfer cannot be reversed; therefore the reference number may be considered proof of payment. If the payment is used to purchase goods or services then these items may be released upon receipt of the reference number.

Additionally, supplemental wire transfer information may be provided to the general ledger system to improve reconciliation of payments and invoices. Such information may be used to document an expenditure which matches a particular invoice.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media—e.g., air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

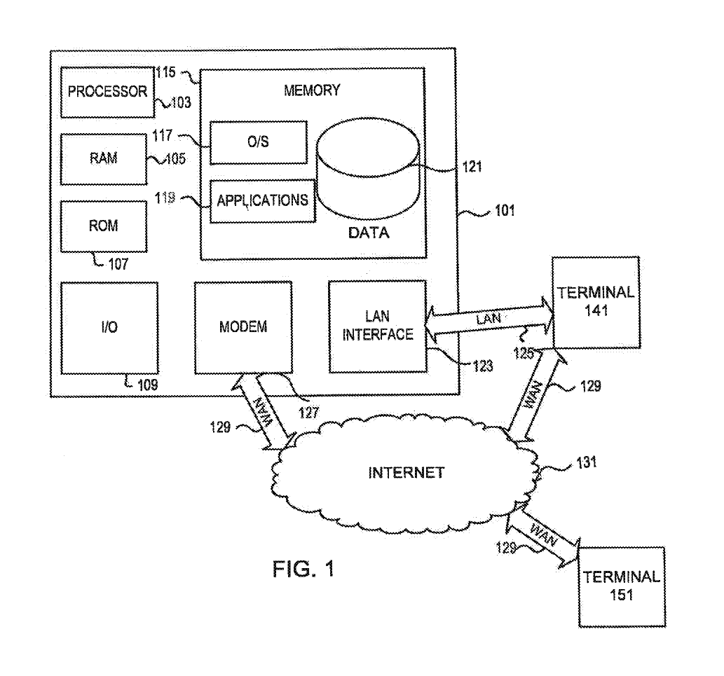

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive payments, wire transfers, payments via checks, debit cards, credit cards, lines of credit or any suitable credit instrument. Likewise, server 101 may be configured to transmit and/or receive information and to provide from/to an Enterprise Resource Planner (“ERP”) or any other suitable system. Further, server 101 may provide confirmation information to one or more payees and facilitate payment approval processing and perform any other suitable tasks related to treasury operation within a cash positioning and reporting system.

Input/output (“I/O”) module 109 may include a microphone, keypad, touch screen, and/or stylus through which a user of device 101 may provide input, and may also include one or more of a speakers for providing audio output and a video display device for providing textual, audiovisual and/or graphical output. Software may be stored within memory 115 to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information, invoices, approvals and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, smartphone, iPhone, or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: treasury operations, wire transfers and any other suitable tasks related to treasury operations.

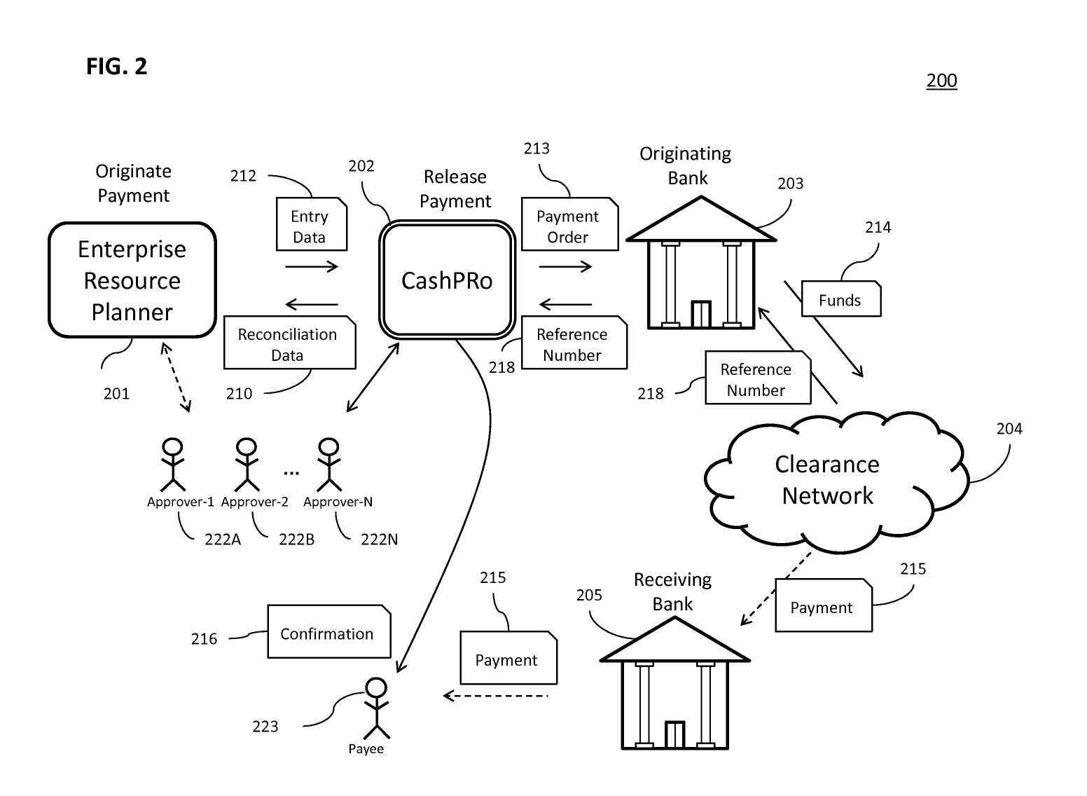

FIG. 2 shows an exemplary schematic of a payment system 200 according to the invention. Payment may originate in an ERP system 201. The ERP system 201 may be an Systems Analysis and Program development (“SAP”) ERP, an Oracle™ system or any other suitable system. The ERP system 201 may generate entry data 212 for a cash positioning and reporting system (“CashPRo”) 202. CashPRo™ system 202 may provide one or more treasury functions. In the alternative, treasury functionality may be provided by a standalone system, distinct from the CashPRo™ system 202.

Entry data 212 may include an invoice or several invoices. Entry data 212 may use any suitable format including standard formats. Entry data 212 may be sent from the ERP system 201 to CashPRo™ system 202 electronically or manually. Each field of the data may be verified for correctness as is described in U.S. patent publication 2009-0319429 and is hereby incorporated by reference.

Prior to the transfer of entry data 212 to the CashPRo™ system 202 an approval process may be required. The approval process may start in ERP system 201 and continue in CashPRo™ system 202 or it may be completely contained within CashPRo™ system 202. There may be separate approval processes for each of ERP system 201 and CashPRo™ system 202. Typically the CashPRo™ system 202 requires an approval process.

The CashPRo™ system 202 may facilitate an approval process that involves one or more approvers. An exemplary chain of approvers are shown as Approver-1 222A, Approver-2 222B through other approvers until the final approver, Approver-N 222N. The configuration of approval depends on customer preferences. No approval at all is contemplated and included within the scope of the invention.

After a successful conclusion to the approval process, CashPRo™ system 202 may produce a payment order 213, which may be sent to an originating bank 203. Payment order 213 may include a transaction number. Payment order 213 may be delivered by electronic, manual or any other suitable means.

Originating bank 203 may deliver funds 214 to a clearance network 204. Clearance network 204 may be a wire transfer clearance facility—e.g., the Federal Reserve Bank of the United States. As described above, delivery of funds 214 via a wire transfer to a clearance network 204 cannot be reversed. Delivery of funds may be by electronic, manual or any other suitable means.

Clearance network 204 may return a reference number 218 to originating bank 203. Reference number 218 may be accompanied by supplemental data and a matching transaction number. Originating bank 203 may return reference number 218 and any supplemental data to CashPRo™ system 202. Delivery of reference number 218 by clearance network 204 and/or originating bank 203 may be by electronic, manual or any other suitable means. Reference number 218 may be a clearance reference number as is provided by the Federal Reserve Bank of the United States or any equivalent reference number.

CashPRo™ system 202 may provide confirmation 216 to payee 223. Confirmation 216 may include reference number 218, invoice information and/or any other suitable information. Confirmation 216 may be delivered by electronic, manual or any other suitable means. In some cases a reference number 218 may not be provided. In some cases reference number 218 may be provided but would not be included in confirmation 216.

CashPRo™ system 202 may provide reconciliation data 210 to ERP 201. Reconciliation data 210 may include reference number 218 and any other suitable information including a transaction number. Reconciliation data 210 may be delivered by electronic, manual or any other suitable means.

Clearance network 204 may provide payment 215 to receiving bank 205. Receiving bank 205 may provide payment 215 to payee 223. All payments may be transferred by electronic, manual or any other suitable means.

Although a single ERP 201, CashPRo™ system 202, originating bank 203, clearance network 204, receiving bank 205 and payee 223 are shown, more than one of any of the aforementioned items are contemplated and are included within the scope of the invention. Likewise, multiple entry data sets, payments orders, funds, reference numbers, confirmations, reconciliation data and invoices are contemplated and are included within the scope of the invention. Further, multiple items may be included in a single item—e.g., multiple invoices may be included in a single entry data 212.

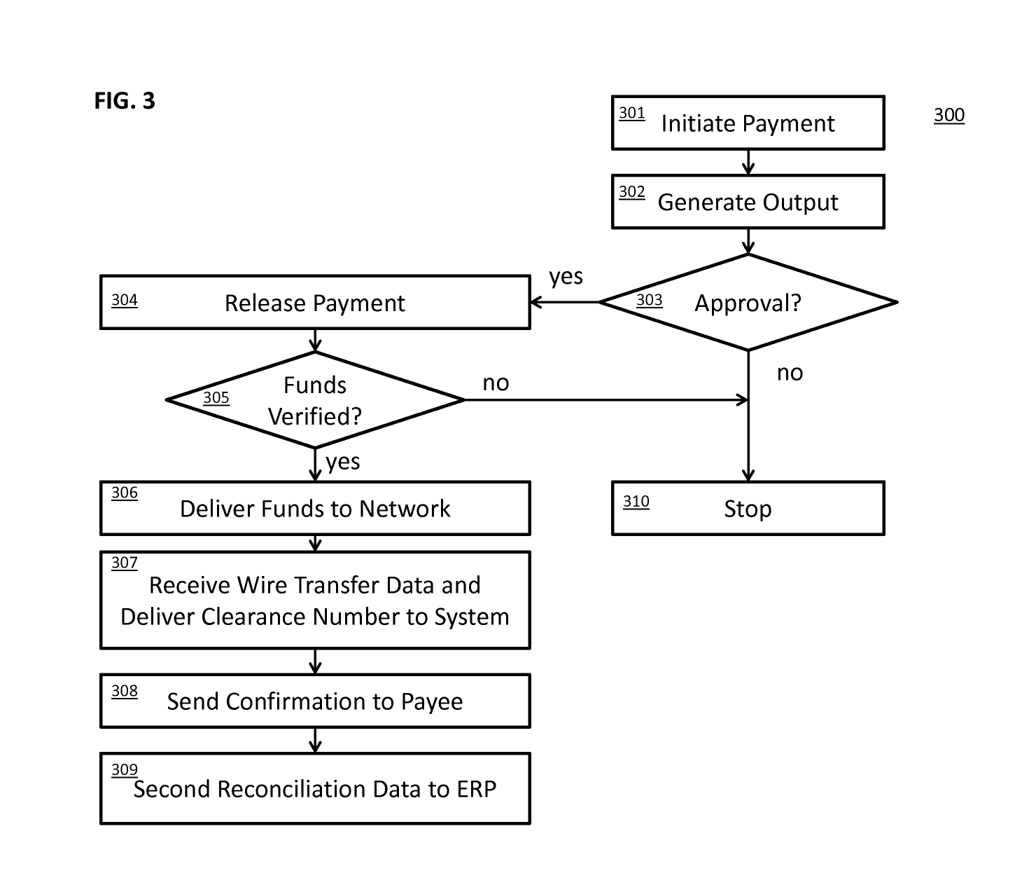

FIG. 3 is a flow chart showing an embodiment 300 of the steps of a process which implements a payment system according to the invention. Although reference will be made to elements of FIG. 2, other ERP, CashPRo™ systems, banks and clearance networks, reference numbers, etc., may be used in this embodiment or any suitable variation of this embodiment. At step 301 payment may be initiated. Payments may be initiated by an external system such as SAP™, Oracle™ or any other suitable ERP system—e.g., ERP 201—for entry to the CashPRo™ system 202. Payments may also be initiated by the CashPRo™ system 202 itself.

At step 302, entry data for the CashPRo™ system 202 may be generated, typically from a suitable ERP system 201. Entry data may include an invoice or multiple invoices. Entry data may use any suitable format, including standard formats.

Each field of the data may be verified for correctness. In certain embodiments of the invention, any of the fields described in the application may be verifiable in real-time. For example, data may be entered into certain fields and the data may be verified in real-time; upon entry into the fields. In such embodiments, repetitive tasks such as re-entering data, may be eliminated because the system and/or method according to the invention may preferably indicate to the user that the data entered into a selected field is improperly formatted.

In certain embodiments, systems and/or methods according to the invention may be set to auto-correct formatting errors, such as the formatting errors described above. In some embodiments, systems and/or methods according to the invention may inform the user of the formatting error and query the user regarding whether the user desires an automatic reformatting of the field.

Next, at step 303, the payment may be approved by the CashPRo™ system 202. If the payment is not approved then the process stops at step 310. If the payment is approved then a payment order may be released at step 304 to an originating bank—e.g., originating bank 203.

Next, at step 305 the originating bank 203 may verify the existence of funds sufficient to make the payment. If sufficient funds are not available then the process stops at step 310. If sufficient funds are available then the originating bank 203 may deliver the funds to a clearance network—e.g., clearance network 204—at step 306. Clearance network 204 may be a wire transfer clearance facility.

At step 307, the originating bank 203 may receive wire transfer information which may include a reference number 218. The originating bank may confirm that the destination bank information is valid as well as confirming the amount of the online validation. This information may also be transferred to CashPRo™ system 202.

In certain embodiments of the invention, user screens may be unique to a designated country. As such, the fields in such screens may correspond to the data requirements of the country. In such embodiments, repetitive tasks such as determining which data is required for which country, may be eliminated because the system and/or method according to the invention provides country-specific screens; preferably with country-specific formatting requirements.

At step 308, the CashPRo™ system may send a confirmation to a payee which is to receive the payment initiated by ERP 201. The confirmation may include an invoice number, the reference number from the wire transfer, the amount of the transfer or any other suitable information.

At step 309 reconciliation data may be sent from the CashPRo™ system 202 to ERP 201. Reconciliation data 210 may include reference number 218.

All data, payments etc. sent between entities in the embodiment 300 may be via electronic, manual or any other suitable means.

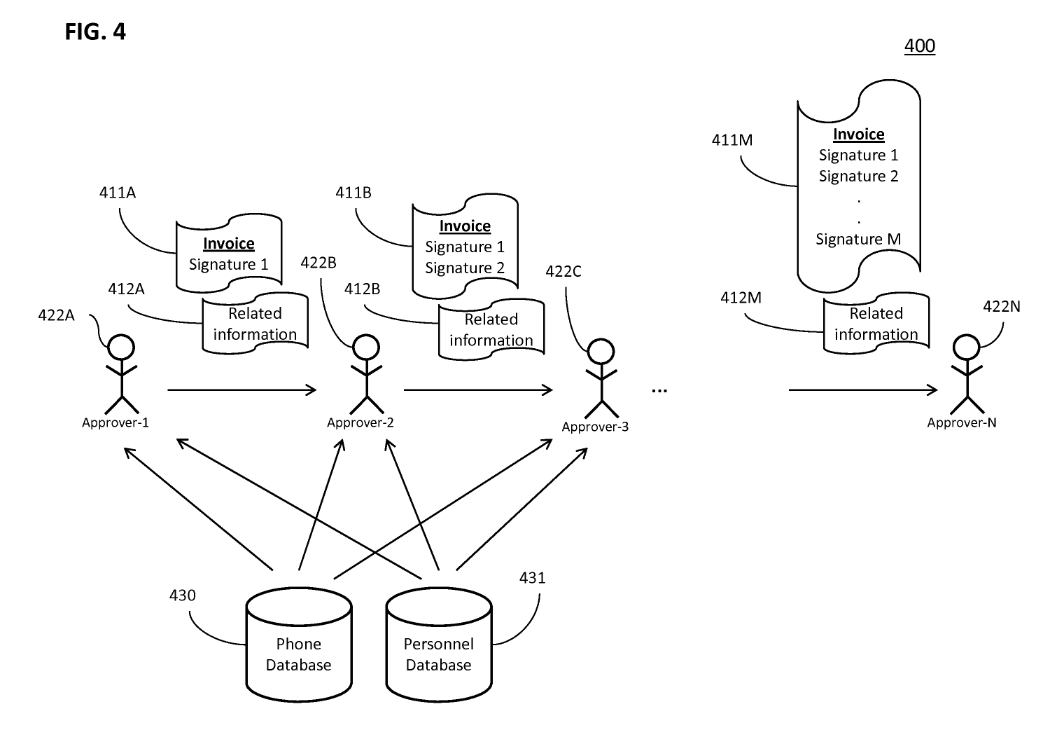

FIG. 4 shows a schematic of an embodiment of an approval process 400 that may be implemented by CashPRo™ system 202. An approval process typically involves multiple approvers as described above. FIG. 4 shows a system utilizing a sequence of approvers designated as Approver-1 422A, Approver-2 422B, Approver-3 422C through Approver-N 422N. Although N approvers are shown, as few as one approver or more than N approvers are contemplated and included within the scope of the invention.

The approval process may be initiated by the first approver, who may generate an invoice, or the invoice may be generated externally to the CashPRo™ system 202. Typically the invoice is derived from entry data 212 sent to the CashPRo™ system 202. The entry data 212 may include an invoice or it may cause the generation of an invoice. Although this description shows the approval of an invoice, approval of internal memos or other suitable documents are contemplated and included within the scope of the invention. Likewise the approval process may approve multiple invoices at once or an invoice and other associated documents—e.g., a contract.

First approver 422A may approve or disapprove the invoice. If the invoice is approved, first approver 422A may send a first approved invoice 411A, or invoice approval in some other suitable fashion, to the next approver, 422B. The first signed invoice 411A may include a first signature, signature-1, which is associated with the first approver 422A. If the first approver 422A disapproves the invoice, then the invoice may be changed or the process may be halted.

The approval may be signed via a secure system password, cryptographic means, biometric means, a handwritten signature or any suitable combination of those means.

The first signed invoice 411A may be accompanied by first related information 412A. First related information 412A may include information about the invoice such as the project number, project title, budget info, the budget used—e.g., expense budget or capital budget—or any other suitable information. First related information 412A may also have information about the first approver 422A such as contact information, rank, approval limitations, if the approval is actually a delegate for another, the date when a delegation will lapse or any other suitable information about the approver.

The second approver 422B may contact the first approver 422A or any preceding approver, using the information in the first related information 412A. In the alternative, contact information for preceding approvers may be stored on a device used by second approver 422B. The second approver 422B may confirm certain details about the invoice or may send the invoice back to first approver 422A for changes and a new signature. In the alternative, only the changes may be signed.

The second approver 422B may approve or disapprove the invoice. If the invoice is approved, second approver 422A may send a second signed invoice 411B to the next approver, 422C. The second signed invoice 411B may include a first signature, signature-1 which is associated with the first approver 422A and a second signature signature-2 related to the second approver 422B. If the second approver 422B disapproves the invoice, then the invoice may be changed or the process may be halted.

Second signed invoice 411B may be accompanied by second related information 412B. Second related information 412B may include information about the invoice as described above. Second related information 412B may also have information about the first approver 422A and the second approver 422B as described above.

The third approver 422C may contact any of the preceding approvers using the information in the second related information 412B. In the alternative contact information for preceding approvers may be stored on a device used by third approver 422C. The third approver 422B may confirm certain details about the invoice or may send the invoice back to a preceding approver for changes and a new signature or signatures. If the invoice is transferred to the first approver 422A then second approver 422B may also sign the changed invoice. Alternately, approvers may be skipped after an initial signature process. In another alternative, at each stage, only the changes may be signed.

The last signed invoice 411M is sent to approver-N 422N. The last invoice 411M may have the signatures of all preceding approvers. Last related information 412M may accompany last signed invoice 411M. The last related information 412M may include information about the invoice as described above. Last related information 412M may also have information about all preceding approvers as described above.

Last signed invoice 411M may be the (N−1)th invoice in the approval chain and may include N−1 signatures. Likewise relating information 412M may be the (N−1)th related information in the approval chain.

The Nth approver 422N may contact any of the preceding approvers using the information in the last related information 412B. The Nth approver 422N may confirm certain details about the invoice or may send the invoice back to a preceding approver for changes and a new signature or signatures.

In the alternative, each invoices 411A-411M may include only the signature of preceding approver. Likewise, the related information 412A-412M may be constant or may only include information about the immediately preceding approver and not information about all preceding approvers.

In the alternative, at each step of the approval process, contact information may be obtained by any approver from phone database 430. Likewise, rank, approval limitation etc. may be obtained from personnel database 431. Signatures in various signed invoices may be used to lookup information in one or more databases. Invoice information may also be obtained from a database (not shown).

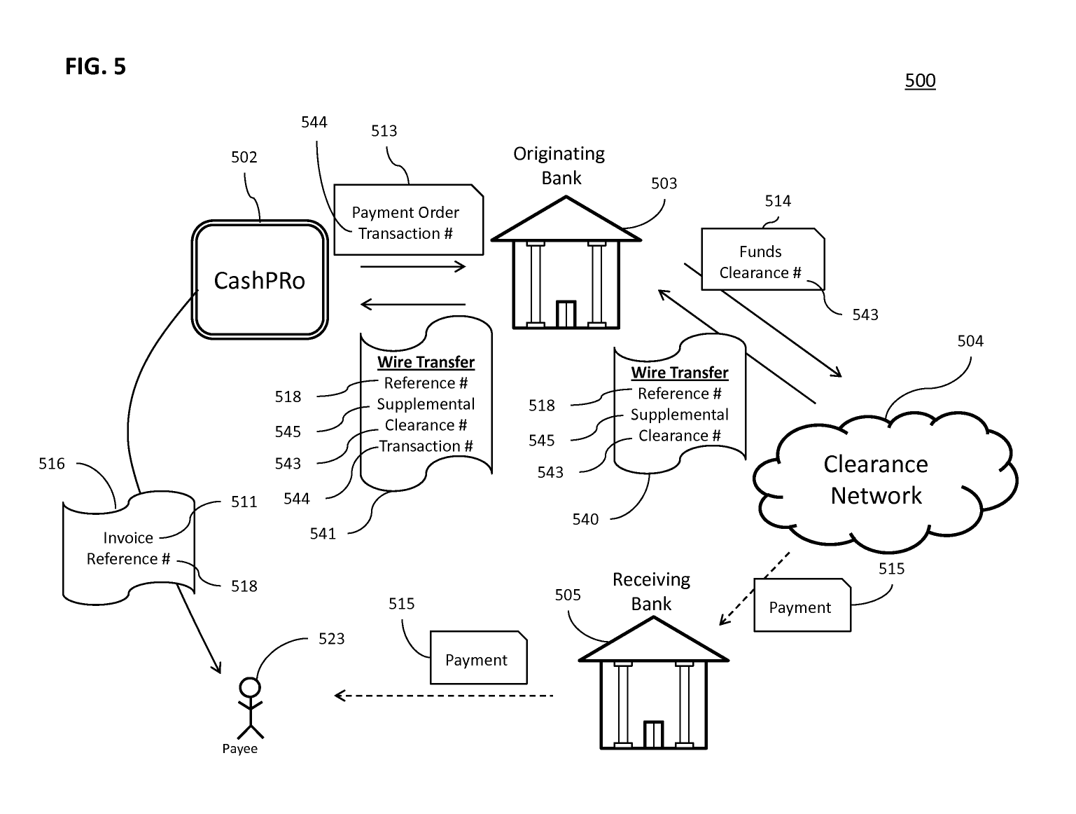

FIG. 5 shows a schematic of an embodiment of an confirmation system 500 according to the invention. Payment may be sent from an ERP system (not shown) to CashPRo™ system 502. CashPRo™ system 502 may provide one or more treasury functions. In the alternative, treasury functionality may be provided by a standalone system, distinct from the CashPRo™ system 502.

The CashPRo™ system 502 may facilitate an approval process that involves one or more approvers. After a successful conclusion to the approval process, CashPRo™ system 502 may produce a payment order 513, which may be sent to an originating bank 503. Payment order 513 may include a transaction number 544, which may be used for tracking the payment. Payment order 513 may be delivered by electronic, manual or any other suitable means.

Originating bank 503 may deliver funds 514 to a clearance network 504. Clearance network 504 may be a wire transfer clearance facility. Typically, delivery of funds 514 to a clearance network 504 cannot be reversed as described above. Funds 514 may be accompanied by a clearance number 543. Clearance number 543 may be used for tracking funds 514. In the alternative, reference number 618 may be used for all tracking of funds 514. Clearance network 604 may be a wire transfer clearance facility. Delivery of funds may be by electronic, manual or any other suitable means.

In one alternative embodiment clearance number 543 is a wire processing number generated by a wire processing system utilized by originating bank 503. In another alternative embodiment clearance number 543 is a transaction reference number generated by originating bank 503. This transaction reference number is distinct from transaction number 544 included in payment order 513. In yet another alternative embodiment originating bank 503 generates a transaction reference number which corresponds to a wire processing number. Either the transaction reference number or the wire processing number or even a third number may be utilized as clearance number 543.

Clearance network 504 may provide payment 515 to receiving bank 505. Receiving bank 505 may provide payment 515 to payee 523. Payment 515 may include reference number 518. All payments may be transferred by electronic, manual or any other suitable means.

Clearance network 504 may return a wire transfer response 540 to originating bank 503. Wire transfer response 540 may include reference number 518, supplemental information 545 and clearance number 543.

Originating bank 503 may send amended wire transfer response 541 to CashPRo™ system 502. Amended wire transfer response 541 may include reference number 518, supplemental information 545, clearance number 543 and transaction number 544.

CashPRo™ system 502 may send a confirmation 516 to payee 523. Conformation 516 may include an invoice 511, invoice number, reference number 518 and some or all of supplemental information 545. The payee may use the reference number 518 or any portion of the confirmation 516 to track the progress of payment 515.

Invoice 511 may or may not include signatures from approval process 400. Although a single invoice 511, payment 515, funds 514, wire transfer 540, reference number 518, supplemental information 545, payment order 513, confirmation 516, clearance number 543 and transaction number 544 are shown, multiple versions of each item or none of one or more of these items are contemplated and are included within the scope of the invention.

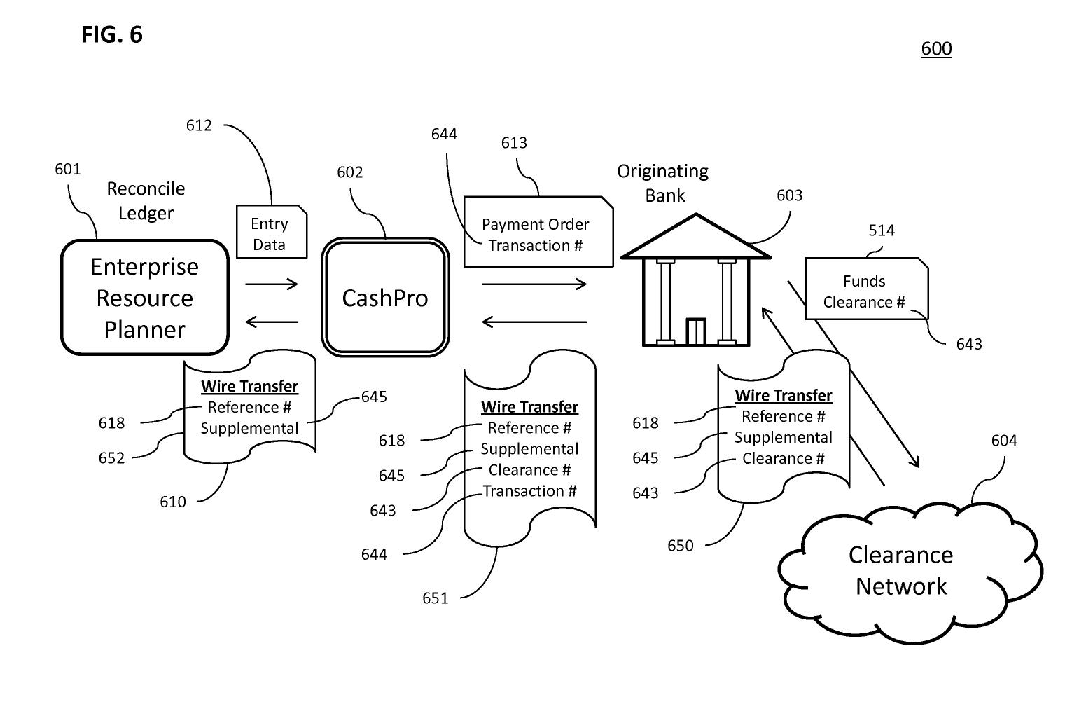

FIG. 6 shows an exemplary schematic of a reconciliation system 600 according to the invention. Payment may originate in an ERP system 601. The ERP system 601 may be a SAP™, Oracle™ or any other suitable system. The ERP system 601 may generate entry data 612 for CashPRo™ system 602. CashPRo™ system 602 may provide one or more treasury functions. In the alternative treasury functionality may be provided by a standalone system, distinct from the CashPRo™ system 602.

Entry data 612 may include an invoice or several invoices. Entry data 612 may use any suitable format including standard formats. Entry data 612 may be sent from the ERP system 601 to CashPRo™ system 602 electronically or manually.

The CashPRo™ system 602 may facilitate an approval process that involves one or more approvers. After a successful conclusion to the approval process, CashPRo™ system 602 may produce a payment order 613, which may be sent to an originating bank 603. Payment order 613 may include a transaction number 644, which may be used for tracking the payment. Payment order 613 may be delivered by electronic, manual or any other suitable means.

Originating bank 603 may deliver funds 614 to a clearance network 604. Funds 614 may be accompanied by a clearance number 643. Clearance number 643 may be used for tracking funds 614. In the alternative, reference number 618 may be used for all tracking of funds 614. Clearance network 604 may be a wire transfer clearance facility. Typically, delivery of funds 614 to clearance network 604 cannot be reversed as described above. Delivery of funds may be by electronic, manual or any other suitable means.

Clearance network 604 may return a wire transfer response 650 to originating bank 603. Wire transfer response 650 may include a reference number 618, supplemental information 645 and clearance number 643. Wire transfer response 650 may be identical to wire transfer response 540.

Originating bank 603 may send amended wire transfer response 651 to CashPRo™ system 502. Amended wire transfer response 551 may include reference number 518, supplemental information 645, clearance number 643 and transaction number 644.

CashPRo™ system 602 may provide reconciliation data 610 to ERP 601. Reconciliation data 610 may include reference number 618 and reconciliation information 652. Reconciliation data 610 and wire transfer responses 650 may be delivered by electronic, manual or any other suitable means.

Reconciliation information 652 may include portions of supplemental information 645 and/or invoice information. Reconciliation information 652 may include other supporting documents—e.g., contracts, shipping documents or statements from outside parties. ERP 601 may use reconciliation data 610 to reconcile payments within a general ledger system. Reference number 618 may be used as documentation to confirm payment with regard to a particular invoice.

Instead of an invoice, a bill, a copy of a bill, a check, an Excel™ spreadsheet or any suitable document may be processed.

Thus, apparatus and methods that enhance treasury management functionality for a cash positioning and reporting system are provided.

Persons skilled in the art will appreciate that the present invention can be practiced by other than the described embodiments, which are presented for purposes of illustration rather than of limitation, and that the present invention is limited only by the claims that follow.

What is claimed is:

1. A method of approving a document, the method comprising:
using a processor to provide an electronic document;
using the processor to cause a receiver to receive instructions from a first approver to approve the document, wherein the approval creates an approved document;
using the processor to associate the approved document with related information, wherein at least a portion of the related information characterizes the first approver; and
using the processor to cause a transmitter to transmit the approved document and related information to a second approver.

2. The method of claim 1 further comprising using the processor to receive instructions from the second approver to secondarily approve the approved document, wherein the secondary approval creates a twice approved document.

3. The method of claim 2 further comprising:
using the processor to associate the twice approved document with second related information, wherein at least a portion of the second related information characterizes the second approver; and
using the processor to transmit the twice approved document, the related information and the second related information to a third approver.

4. The method of claim 1, wherein the related information provides contact information which enables the second approver to contact the first approver prior to approving the approved document.

5. The method of claim 1 further comprising:
using a processor to obtain contact information related to the first approver from a database; and
wherein the contact information enables the second approver to contact the first approver prior to approving the approved document.

6. The method of claim 1 wherein the related information comprises destination information related to the first approver.

7. The method of claim 1 wherein the related information comprises invoice information related to the document.

8. The method of claim 1 wherein the approved document is an electronically-signed document.

9. The method of claim 1 wherein the approved document includes the rank of the approver.

10. The method of claim 1 wherein the approved document comprises the delegation status of the approver.

11. The method of claim 1 wherein the approved document comprises the approval limitations of the approver.

12. A device for approving a document, the device comprising:
an electronic document;
an approved document wherein the approved document is the electronic document approved by a first approver; and
a receiver for receiving information related to the approved document,
wherein at least a portion of the related information characterizes the first approver, and
wherein the approved document and the related information is transmitted to a second approver.

13. The device of claim 12 further comprising a twice approved document wherein the twice approved document is the approved document approved by the second approver.

14. The device of claim 13 further comprising, second related information, wherein at least a portion of the second related information characterizes the second approver, wherein the twice approved document and related information and the second related information are transmitted to a third approver.

15. The device of claim 12 wherein the related information comprises contact information descriptive of the first approver.

16. The device of claim 12 further comprising a database comprising contact information related to the first approver.

17. The device of claim 12 wherein the related information comprises invoice information related to the electronic document.

18. The device of claim 12 wherein the approved document is a signed document.

19. The device of claim 12 wherein the approved document comprises the rank of the approver.

20. The device of claim 12 wherein the approved document comprises the delegation status of the approver.

21. The device of claim 12 wherein the approved document comprises the approval limitations of the approver.

22. One or more non-transitory, computer-readable, media storing computer-executable instructions which, when executed by a processor on a computer system, perform a method for approving a document, the method comprising:
using the processor to provide an electronic document;
using the processor to receive instructions from a first approver to approve the document, wherein the approval creates an approved document;
using the processor to associate the approved document with related information, wherein at least a portion of the related information characterizes the first approver; and
using the processor to transmit the approved document and related information to a second approver.
